(19) United States
(12) Patent Application Publication
(10) Pub. No.: US 2026/0067315 A1
(43) Pub. Date: Mar. 5, 2026

(54) MACHINE LEARNING BASED ALERT PRIORITY SCORING BASED ON CUSTOMER ALERT RESOLUTION BEHAVIOR

(71) Applicant: Palo Alto Networks, Inc., Santa Clara, CA (US)

(72) Inventors: Ruben Dario Torres Guerra, Menlo Park, CA (US); Alok Tongaonkar, San Jose, CA (US)

(21) Appl. No.: 18/816,254

(22) Filed: Aug. 27, 2024

(51) Int. Cl. H04L 9/40; G06N 20/20

(52) U.S. Cl. CPC H04L 63/1433; G06N 20/20; H04L 63/1416

(57) ABSTRACT

A system has been created that scores alerts to facilitate alert prioritization by leveraging a classifier trained with cross-organization training data and a classifier trained with single organization training data. When an alert is detected, the system extracts feature values for a cybersecurity feature set from the alert and metadata of a relevant asset to generate a first feature vector that is then fed into an organization agnostic classifier to obtain a first importance classification. The system also extracts feature values for a second feature set from metadata of the relevant asset to generate a second feature vector that is then fed into an organization specific alert classifier to obtain a second importance classification. The ensemble aggregates the importance classifications into a score that can then be used to prioritize the alert relative to other alerts.

### BACKGROUND

The disclosure generally relates to managing cybersecurity alerts using machine learning (e.g., CPC subclass G06F and CPC subclass G06N 20/00).

Cloud security posture management (CSPM) refers to management of security risks of cloud infrastructure, cloud infrastructure encompassing the software and hardware resources of a cloud service provider (CSP). For a customer of a CSP, CSPM refers to management of the security risks to customer cloud assets (i.e., application(s), workload, and/or data). While the CSP is responsible for CSPM of the infrastructure provided by the CSP, the CSPM of customer assets involves monitoring assets for risks and compliance auditing based on policy definitions, scanning to ensure policy compliance, and remediation of detected risks. Scanning or searching for risks, such as misconfigurations, can be across cloud environments/infrastructure of different delivery models including Infrastructure as a Service (IaaS), Platform as a Service (PaaS), and Software as a Service (Saas).

Policy definitions or policies are created and configured with conditions for generating alerts and for classifying alerts with severity levels (i.e., different levels of impact on an organization). A basic classification of alerts by severity levels would be into critical alerts and non-critical alerts. More likely, the non-critical alerts are classified with more specificity corresponding to the different levels of severity below critical of interest to an organization or as defined by a cybersecurity service provider or system.

### BRIEF DESCRIPTION OF THE DRAWINGS

Embodiments of the disclosure may be better understood by referencing the accompanying drawings.

FIG. 1 is a diagram of training pipelines for an organization agnostic alert classifier and for an organization specific alert classifier.

FIG. 2 is a diagram of a system using an ensemble of an organization agnostic alert classifier and an organization specific alert classifier to score priority of an alert detected in an organization.

FIG. 3 is a flowchart of example operations for training models to classify alerts for prioritization from an organization agnostic cybersecurity perspective and from a single organization asset perspective and for joining the models to create a priority scoring ensemble.

FIG. 4 is a flowchart of example operations for training an organization specific alert classifier with the training samples created from a single organization alert and asset metadata.

FIG. 5 is a flowchart of example operations for training an organization agnostic classifier with the training samples created from alert data, alert metadata, and asset metadata across multiple organizations.

FIG. 6 is a flowchart of example operations for scoring an alert based on an aggregate of priority classifications.

FIG. 7 depicts an example computer system with an alert priority scoring system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description refers to inaccurately classifying alerts in terms of inaccurately classified impact level. This “inaccurate” classification does not mean incorrect classification. An alert may be classified as high impact level because it may be high impact as understood by the policy author and/or generally for organizations, but will not necessarily be high impact for a particular organization.

In this description, a “training sample” refers to values of a feature set that have been extracted from raw training data and a label (i.e., expected classification or prediction). A feature vector is generated from the feature set values and the feature vector labeled with the label. The feature vector may be populated with some or none of the raw values depending upon the values. In most cases, the feature vector is populated with values derived from the raw values due to scaling, encoding, etc.

The description refers to “prioritization” and “importance” when describing what the machine learning models learn and the scoring. These terms and their variants represent a binary classification to aid in prioritizing alerts. Classifying an alert as being priority or not priority has the same meaning for this disclosure as classifying an alert as important or not important and does not carry the additional semantic meaning. For instance, a label of “not important” does not mean a corresponding alert was not important but merely a label or class identifier being used to differentiate alerts for prioritization. The specific naming of the classes should not be used to limit claim scope. The classifications could be “attention” or “no attention”, or even “red” and “not red” as long as it provides a classification that can be used to differentiate alerts.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Introduction

A policy author/administrator will create and configure an alert policy that specifies conditions for alerts to be generated (e.g., triggers for various cloud asset misconfigurations to generate an alert when detected) and how to classify/label the generated alerts (e.g., critical, impactful, error, informative). This manually driven policy creation and configuration cannot expeditiously adapt to changes in an organization's preferences and can yield inaccurately classified alerts. Inaccurately classified alerts lead to critical alerts being ignored and/or informational alerts overwhelming cybersecurity personnel. Even without accurately classified alerts, the volume of alerts still overwhelms limited cybersecurity personnel who rely on prioritization of the alerts. Alerts are not only generated for deployed assets, but the expansion of security into DevOps expands alerts in terms of types of assets (e.g., workloads, program code, storage, documents, endpoints, etc.) and in terms of time (e.g., alerts generated across the lifecycle of program code and the artifacts of program code). Current prioritization, however, is static and based on a limited view, such as prioritizing based on the alert corresponding to risks versus incidents or prioritizing by cybersecurity domain (e.g., CSPM and cloud workload protection (CWP)).

### Overview

A system has been created that scores alerts to facilitate alert prioritization by leveraging a classifier trained with cross-organization training data and a classifier trained with single organization training data. Training a machine learning model with cross-organization training data provides a richer training dataset across a feature set (“organization agnostic security feature set”) that includes cybersecurity based features and cloud-asset based features. This facilitates a machine learning model learning organization agnostic prioritization of alerts based on alert-based and asset-based security features and yields an organization agnostic alert classifier that classifies alerts accordingly. Training another machine learning model with another asset-based feature set (“preference feature set”) from the single organization training data facilitates the machine learning model learning an organization's alert prioritization preferences with respect to features of assets with alerts chosen to be resolved and yields an organization specific alert classifier. The organization agnostic alert classifier and the organization specific alert classifier are combined to produce an alert priority scoring ensemble that scores an alert based on priority/importance classifications.

When an alert is detected, the system extracts feature values for the organization agnostic security feature set from the alert and metadata of a relevant asset to generate a first feature vector that is then fed into the organization agnostic classifier to obtain a first importance classification. The system also extracts feature values for the preference feature set from metadata of the relevant asset to generate a second feature vector that is then fed into the organization specific alert classifier to obtain a second importance classification. The ensemble aggregates the importance classifications into a score that can then be used to prioritize the alert relative to other alerts. In addition, the system can perform feature importance analysis to provide context for the scoring.

### Example Illustrations

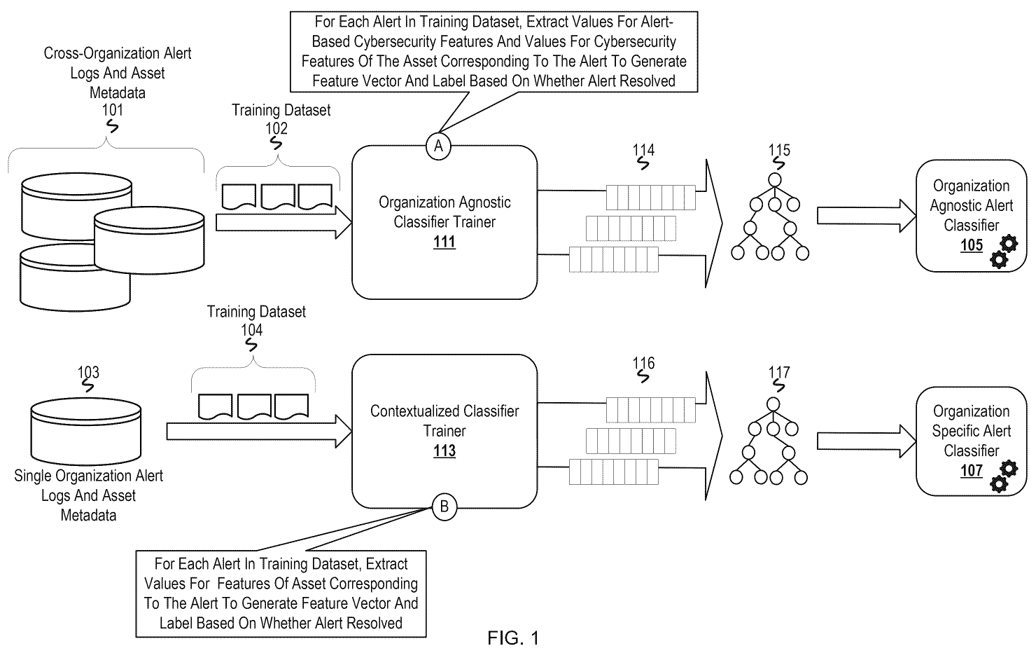

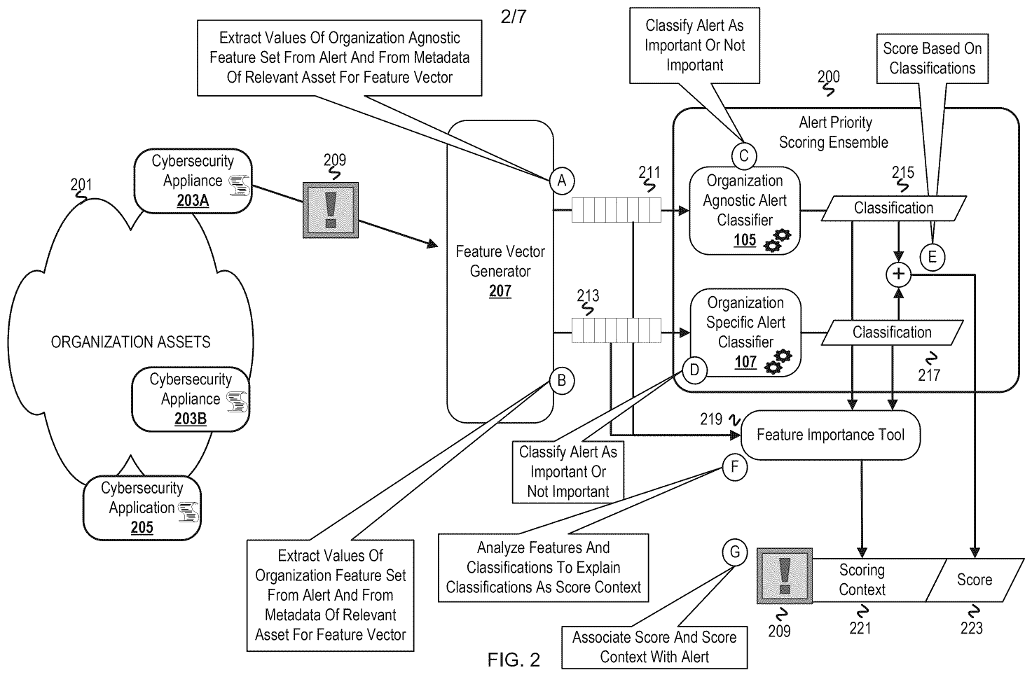

FIGS. 1-2 are diagrams that illustrate the training of machine learning models to produce trained classifiers and use of the trained classifiers in an ensemble for alert priority scoring. FIG. 1 is a diagram of training pipelines for an organization agnostic alert classifier and for a contextualized alert classifier. FIG. 2 is a diagram of a system using an ensemble of an organization agnostic alert classifier and an organization specific alert classifier to score priority of an alert detected in an organization. Each of FIGS. 1-2 is annotated with a series of letters that each indicate a stage of one or more operations. Although these stages are ordered for this example, the stages illustrate one example to aid in understanding this disclosure and should not be used to limit the claims. Subject matter falling within the scope of the claims can vary from what is illustrated. FIG. 1 depicts stages A and B.

FIG. 1 depicts two machine learning training pipelines. The first machine learning training pipeline is depicted with a data source(s) 101, an organization agnostic classifier trainer 111, and a machine learning model 115. The second machine learning training pipeline is depicted with a data source 103, an organization specific alert classifier trainer 113, and a machine learning model 117. The machine learning models 115, 117 can be the same or different supervised machine learnings models. Examples of either of the machine learning models 115, 117 include an artificial neural network, a logistic regression model, a random forest, and support vector machine. The difference between the trainers 111, 113 corresponds to the types of the machine learning models 115, 117 and the feature sets used to train the machine learning models 115, 117. If the machine learning models 115, 117 are the same type of machine learning model, then the difference in trainers 111, 113 would be in the pre-processing corresponding to the different feature sets.

In addition to the different features sets, the machine learning training pipelines (hereinafter “training pipelines”) retrieve values/data corresponding to the different features sets from the different data sources 101, 103. The first training pipeline that produces an organization agnostic alert classifier 105 retrieves a training dataset 102 from the data source 101, which is alert logs and asset metadata from across multiple organizations or enterprises (“cross-organization data”). Deriving training data from cross-organization data leverages a larger knowledge and experience base expressed through the various alerts and assets occurring across multiple organizations. The organization agnostic classifier trainer 111 queries the data source 101 for the training dataset 102 which at least includes alerts, status of the alerts (resolved or not resolved), and cybersecurity metadata of assets corresponding to the alerts. The alert-based raw training data retrieved by the organization agnostic classifier trainer (classifier trainer) 111 includes data of cybersecurity related features of the asset data, such as policy severity and common vulnerability scoring system (CVSS) score. The asset-based raw training data retrieved by the trainer 111 also includes data of cybersecurity related features, such as statistical cybersecurity features (e.g., number of critical vulnerabilities of the asset, number of total issues of the asset, number of critical external issues of the asset) and highest vulnerability exploit prediction scoring system (EPSS) score of the asset.

At stage A, the classifier trainer 111 generates training samples or labeled feature vectors 114 for each alert to train the machine learning model 115 and produce the organization agnostic alert classifier 105. The classifier trainer 111 extracts for each alert in the training dataset 102 values for the alert-based cybersecurity features and values for the asset-based cybersecurity features (i.e., the cybersecurity features of the asset corresponding to the alert.). For each alert, the classifier trainer 111 generates a feature vector with the extracted values and labels the feature vector based on whether the alert was resolved or not. Assuming “important” is a class, the classifier trainer 111 labels feature vectors for resolved alerts as important (i.e., it was resolved so is presumably important relative to unresolved alerts) and unresolved alerts as not important.

The second training pipeline which produces an organization specific alert classifier 107 retrieves a training dataset 104 from the data source 103, which is alert logs and asset metadata for a single organization or enterprise. Focusing the training data on the data of the organization for which the classifiers 105, 107 will be deployed incorporates an organization specific perspective to include with the organization agnostic perspective for alert classification. The organization specific alert classifier trainer 113 queries the data source 103 for training dataset 104 which at least includes alerts, status of the alerts (resolved or not resolved), and metadata of assets corresponding to the alerts. The asset-based metadata retrieved by the organization specific alert classifier trainer 113 includes data of features of the asset, such as type of policy attached to the asset and asset type.

At stage B, the classifier trainer 113 generates labeled feature vectors 116 for each alert to train the machine learning model 117 and produce the organization specific alert classifier 105. The classifier trainer 113 extracts for each alert in the training dataset 104 values for the asset-based features. For each alert, the classifier trainer 113 generates a feature vector with the extracted values and labels the feature vector based on whether the alert was resolved or not.

In FIG. 2, the organization agnostic alert classifier 105 and the organization specific alert classifier 107 have been deployed as part of an alert priority scoring ensemble 200. In addition to the classifiers, the alert priority scoring ensemble 200 includes program code to aggregate classifications from the classifiers 105, 107. A feature importance tool 219 and a feature vector generator 207 are functionally or communicatively coupled with the alert priority scoring ensemble 200. The feature vector generator 207 is a pre-processing component for the ensemble 200 and the feature importance tool 219 can be considered a post-processing component relative to the ensemble 200. The feature vector generator 207, ensemble 200, and the feature importance tool 219 together form an alert priority scoring system.

For this illustration, the alert priority scoring system is deployed for an organization with organization assets 201. These assets can be on-premises, across data centers of the organization, and cloud-hosted assets. Examples of assets include virtual machines, cloud storage, code repositories, and program code. The organization assets 201 are monitored with cybersecurity appliances 203A, 203B (e.g., firewalls) and a cybersecurity application 205 (e.g., an endpoint protection application, attack surface management application, or code management application). The cybersecurity appliances 203A, 203B and the cybersecurity application 209 may detect any of a variety of cybersecurity issues, examples of which include exploits, workload incidents, anomalous network behavior, identity anomalies, data exfiltration, continuous integration/continuous deployment (CI/CD) misconfiguration, infrastructure as code (IaC) misconfiguration, cloud-hosted asset misconfiguration, malware, exposure, and overly permissive roles. Each of the cybersecurity appliances 203A, 203B and the cybersecurity application 209 enforces at least one policy to detect one or more cybersecurity issues and generates an alert according to the triggered policy. FIG. 2 depicts the cybersecurity appliance 203A generating an alert 209 that is communicated to the alert priority scoring system. FIG. 2 depicts stages A-G commencing after communication of the alert 209 to the alert priority scoring system.

At stage A, the feature vector generator 207 extracts values of the organization agnostic feature set from the alert 209 and from metadata of a corresponding asset. The feature vector generator 207 extracts values of the alert-based cybersecurity features from the alert 209. The feature vector generator 207 identifies the asset corresponding to the alert 209 and then retrieves values of the asset-based cybersecurity features for the asset. The feature vector generator 207 generates a feature vector 211 based on the extracted values. Some raw values may be pre-processed (e.g., scaling or encoding) as part of generating the feature vector 211.

At stage B, the feature vector generator 207 extracts values of the preference feature set from asset data in the alert 209 and/or from metadata of a corresponding asset. The feature vector generator 207 extracts values of the preference features from the alert 209, if any occur in the alert 209. With the asset already identified, the feature vector generator 207 retrieves values of the preference features for the asset. The feature vector generator 207 generates a feature vector 213 based on the extracted values.

At stage C, the organization agnostic alert classifier 105 classifies the alert 209 as important or not important based on the feature vector 211. The feature vector 211 is input or fed into the alert classifier 105. The alert classifier 105 then generates a classification 215, which is a confidence value that the alert 209 is important.

Likewise, at stage D, the organization specific alert classifier 107 classifies the alert 209 as important or not important based on the feature vector 213. The feature vector 213 is input or fed into the organization specific alert classifier 107. The organization specific alert classifier 107 then generates a classification 217, which is also a confidence value that the alert 209 is important.

At stage E, the alert priority scoring ensemble 200 aggregates the classifications 215, 217 into a priority score 223. For example, an aggregation or combination function of the ensemble 200 averages the confidence values of the classifications 215, 217.

At stage F, the feature importance tool 219 analyzes the features and classifications 215, 217 to explain the classifications and provide context for the scoring. The feature importance tool 219 performs statistical analysis to determine feature importance relative to the classifications 215, 217. The feature importance tool 219 receives the feature vector 211 and the classification 215 and determines importance of the features of the feature vector 211 relative to the classification 215. The feature importance tool 219 receives the feature vector 213 and the classification 217 and determines importance of the features of the feature vector 213 relative to the classification 217. As an example, the feature importance tool 219 is a tool that computes and interprets Shapley values (e.g., SHAP (SHapley Additive exPlanations) tool). The feature importance tool 219 generates a scoring context 221.

At stage G, the alert priority scoring system associates the score 223 and the scoring context 221 with the alert 209. For instance, the alert priority scoring system decorates the alert 209 with the scoring context 221 and the score 223. With the score 223, another system or cybersecurity personnel can rank or emphasize alerts relative to each other (e.g., updating graphical dashboards or incidents reports). A system can also automatically select alerts to resolve based on the scoring. In addition, the feature importance analysis or score context provides insight that can enhance prioritization and be used as feedback for feature selection. For instance, alerts in which the organization's handling of the alert does not align with the scoring can be accumulated and then analyzed with respect to the feature importance information to inform feature selection. It may be discovered that a prominent feature in common across alert scores that did not align with how the organization handled the alerts can be flagged for removal from the feature sets.

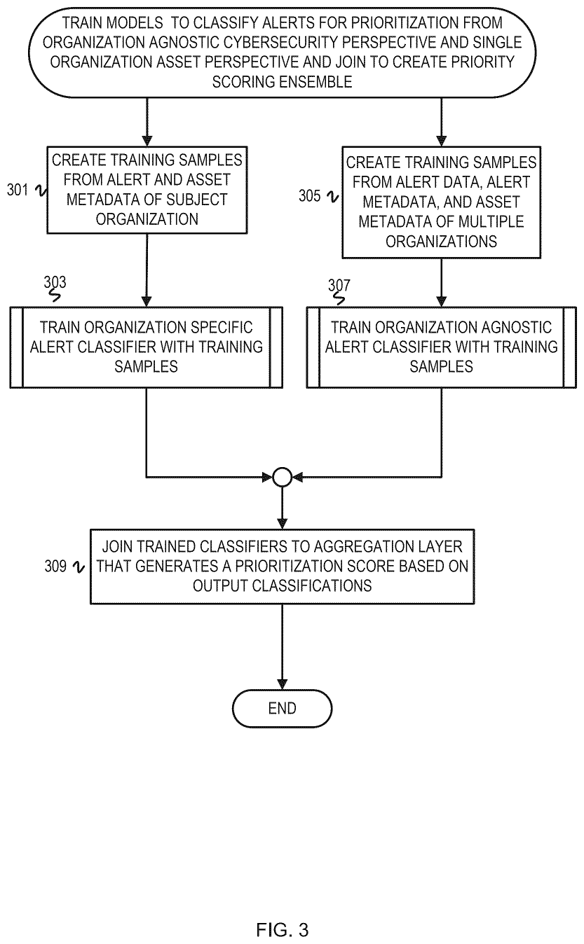

FIGS. 3-6 are flowcharts of example operations for creating an alert priority scoring ensemble and using an alert priority scoring ensemble. The example operations are described with reference to trainers and an alert priority scoring system for consistency with the earlier figures. The names chosen for program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for training models to classify alerts for prioritization from an organization agnostic cybersecurity perspective and from a single organization asset perspective and for joining the models to create a priority scoring ensemble. As described previously, the organization agnostic cybersecurity perspective is agnostic because it learns from data of multiple organizations. This organization agnostic cybersecurity perspective is from alert-based and asset-based cybersecurity features. Thus, the training pipelines have access to data from multiple organizations, and that data includes alert data and corresponding asset metadata. For the single organization asset perspective, the training pipelines have access to the organization's (e.g., a tenant or customer) alert data and asset data. The multiple organization data has likely been anonymized or at least the collection of data avoids propagating any organization identifying information. Training of a machine learning model to produce the organization specific alert classifier corresponds to blocks 301 and 303. Training of a machine learning model to produce the organization agnostic alert classifier corresponds to blocks 305 and 307.

At block 301, a first trainer creates training samples from alert and asset metadata of a subject organization. The first trainer has access to alert logs or an alert repository of an organization for which the ensemble will be used to score alerts. For each alert of the organization indicated for use to create training data, the first trainer identifies a corresponding asset and determines whether the alert was resolved based on alert status. The first trainer will then retrieve metadata of the asset and extract values of preference features. The asset metadata corresponding to the preference features and alarm resolution status together form a training sample. Examples of the preference features include asset type, asset name, asset tags, cloud account identifier, type of policy attached to the asset, type of cloud platform, and region. The training samples allow a machine learning model to distinguish between assets with alerts that are important (i.e., with resolved alerts) and those that are not important (i.e., with unresolved alerts).

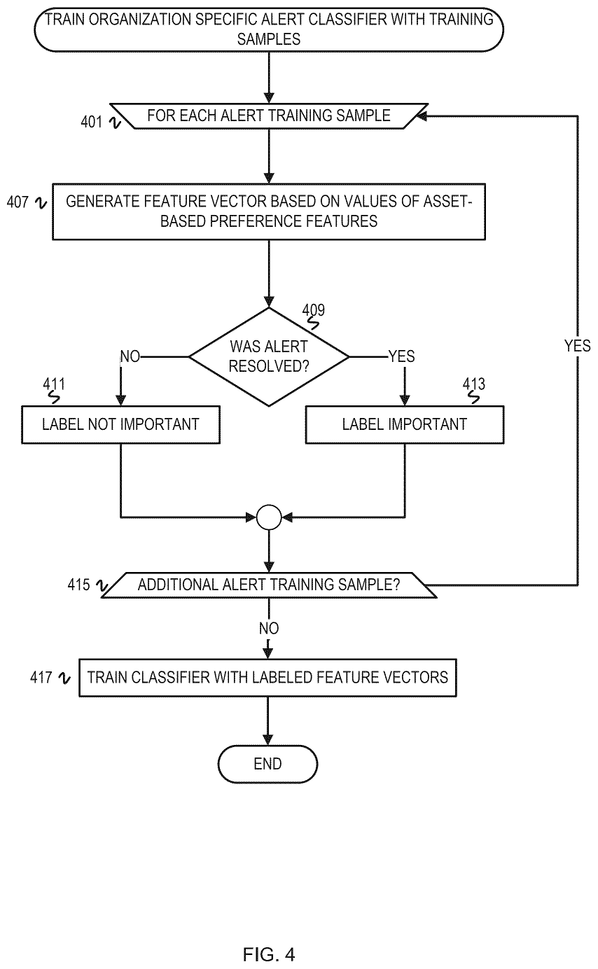

At block 303, the first trainer trains a machine learning model to produce an organization specific alert classifier with the training samples. FIG. 4 provides example operations to elaborate on the training.

At block 305, a second trainer creates training samples from alert data, alert metadata, and asset metadata of multiple organizations. The second trainer has access to alert logs or an alert repository of multiple organizations. For each alert indicated for use to create training data, the second trainer identifies a corresponding asset and determines whether the alert was resolved based on alert status. The second trainer will then retrieve metadata of the alert and the asset. The second trainer extracts values from the alert data, alert metadata, and asset metadata corresponding to cybersecurity features. The extracted values and alarm resolution status together form a training sample. Examples of the alert-based cybersecurity features include severity of the alert as indicated by a corresponding policy, a category of the corresponding policy, complexity of the risk corresponding to the alert, exploitability of the risk corresponding to the alert, CVSS score, EPSS score, and exploitability in the wild of the vulnerability corresponding to the alert. Examples of the asset-based cybersecurity features include whether the asset contains sensitive data, whether the asset is highly privileged, the number of critical issues experienced/caused by this asset or asset configuration, number of vulnerabilities associated with this asset, highest CVSS score of a vulnerability of the asset, highest EPSS score of a vulnerability of the asset, average severity of open findings in one or more time periods, lateral movement capabilities, whether the asset is in a production or staged environment, whether the asset is in an attack path, and whether the asset is part of a security incident. The training samples allow a machine learning model to learn to distinguish between alerts that are important and those that are not important based on commonalities/patterns of both assets and alerts with respect to cybersecurity features.

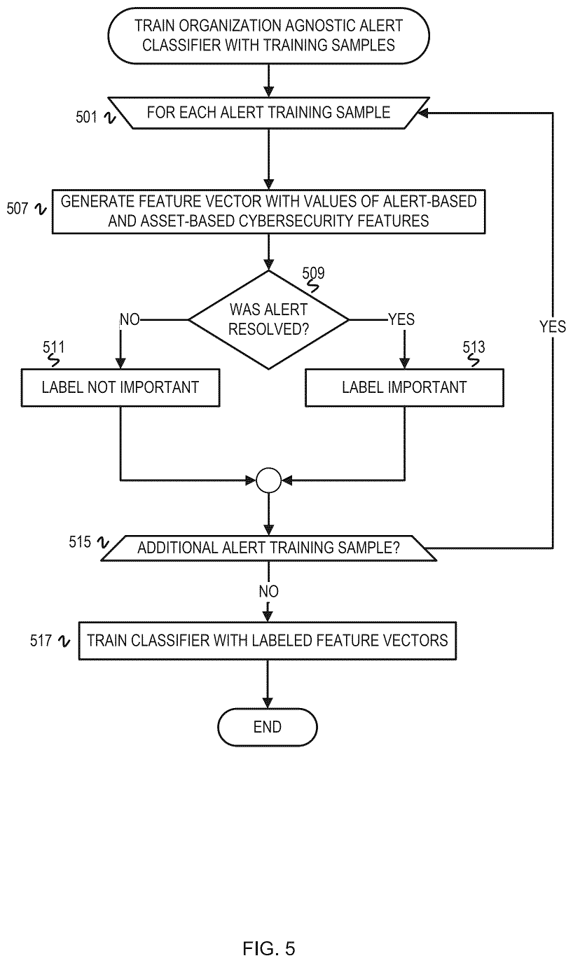

At block 307, the second trainer trains a machine-learning model to produce an organization agnostic alert classifier with the cross-organization training samples. FIG. 5 provides example operations that elaborate on the training of the organization agnostic alert classifier.

At block 309, the alert priority scoring system joins the trained classifiers to produce an ensemble that generates a prioritization score for an alert based on classifications of the classifiers. The alert priority scoring system “joins” the classifiers by adding an aggregation layer. The aggregation layer is program code that aggregates the outputs of the classifiers. The aggregation layer can implement aggregation according to configuration. For instance, the aggregation layer can initially be configured to average the classifications to generate a prioritization score. Implementations can apply weights to each of the classifications to bias a score towards either the organization agnostic perspective of importance or the single organization perspective of importance.

FIG. 4 is a flowchart of example operations for training an organization specific alert classifier with the training samples created from single organization alert and asset metadata. FIG. 4 presumes the training samples with values for the preference features and alert status have already been collected for each alert to be used in training.

At block 401, a trainer begins iterating over the training samples that have been created. The created training samples are likely split between training and validation sets, in which case the trainer begins iterating through the training set of training samples.

At block 407, the trainer generates a feature vector based on values of the asset-based preference features. As mentioned, the trainer may perform pre-processing on some or all of the feature values extracted from the alert and asset metadata.

At block 409, the trainer determines whether the alert corresponding to the training sample was resolved. If the alert was resolved, then operational flow proceeds to block 413. If the alert was not resolved, then operational flow proceeds to block 411.

At block 411, the trainer labels the feature vector as not important. While the description refers to important/not important and resolved/not resolved as labels, the specific string used does not matter since it maps to a 0 or 1 for a binary classifier. Either can be considered a label or resolved/not resolved can be considered a basis for labelling. Operational flow proceeds to block 415.

At block 413, the trainer labels the feature vector as important. Operational flow proceeds to block 415.

At block 415, the trainer determines whether there is another alert training sample to process. If there is another alert training sample to process, then operational flow proceeds to block 401. If not, then operational flow proceeds to block 417.

At block 417, the trainer trains a classifier with the labeled feature vectors. The trainer will input each feature vector into the model and then compare the output to the corresponding label. The machine learning model is adjusted to fit the training samples (e.g., backpropagation, difference target propagation, etc.) without underfitting or overfitting. Training can terminate when the training samples are exhausted or when a termination criterion is satisfied (e.g., degrading validation or specified epochs in training hyperparameters).

FIG. 5 is a flowchart of example operations for training an organization agnostic classifier with the training samples created from alert data, alert metadata, and asset metadata across multiple organizations. FIG. 5 presumes the training samples with values for the asset-based and alert-based cybersecurity features and alert status have already been collected for each alert to be used in training. Some explanatory text is not repeated since the operations of FIG. 5 are similar to those in FIG. 4. At block 501, a trainer begins iterating over the training samples that have been created. The created training samples are likely split between training and validation sets, in which case the trainer begins iterating through the training set of training samples. At block 507, the trainer generates a feature vector based on values of the alert-based cybersecurity features and the asset-based cybersecurity features. As mentioned, the trainer may perform pre-processing on some or all of the feature values extracted from the alert and asset metadata. At block 509, the trainer determines whether the alert corresponding to the training sample was resolved. If the alert was resolved, then operational flow proceeds to block 513. If the alert was not resolved, then operational flow proceeds to block 511. At block 511, the trainer labels the feature vector as not important. At block 513, the trainer labels the feature vector as important. Operational flow proceeds to block 515 from either block 511 or 513. At block 515, the trainer determines whether there is another alert training sample to process. If there is another alert training sample to process, then operational flow returns to block 501. If not, then operational flow proceeds to block 517. At block 517, the trainer trains a classifier with the labeled feature vectors.

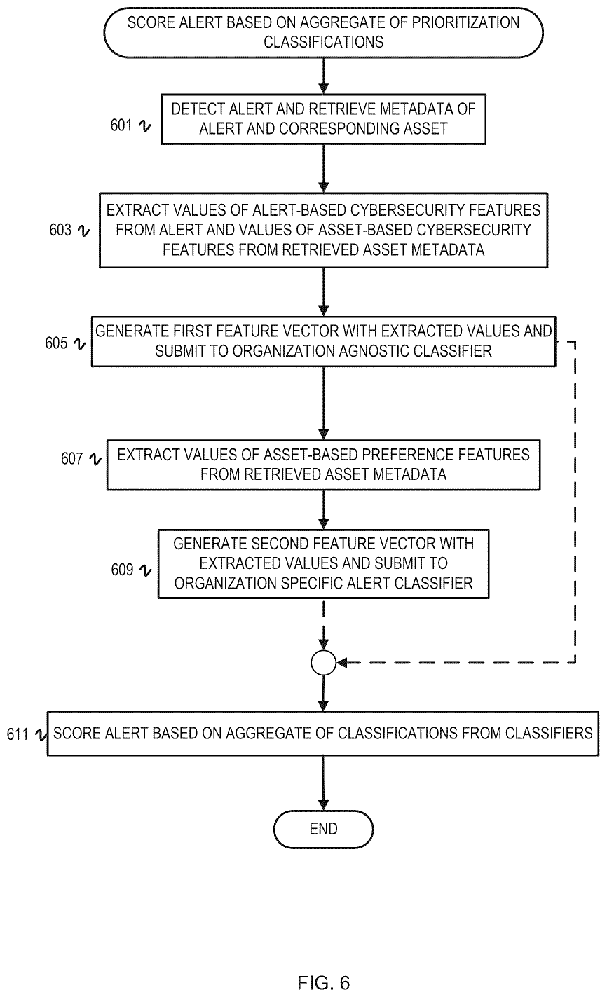

FIG. 6 is a flowchart of example operations for scoring an alert based on an aggregate of priority classifications. An alert priority scoring system will detect an alert or alert notification from a cybersecurity system. The alert priority scoring system can retrieve the alert if not directly conveyed by the cybersecurity system. Dashed lines are used to depict the possible asynchronous relationship between running/invoking a classifier on a feature vector and generation of output by the classifier.

At block 601, the alert priority scoring system detects an alert and retrieves metadata of the alert and the corresponding asset. The alert priority scoring system identifies the asset corresponding to the alert and then retrieves metadata of the asset. The alert priority scoring system also retrieves metadata of the alert since some of the alert-based cybersecurity features are in alert metadata and some are in the alert data. The alert priority scoring system is configured/programmed to retrieve alert data, alert metadata, and asset metadata according to the features used to train the classifiers of the alert priority scoring ensemble.

At block 603, the alert priority scoring system extracts values of alert-based cybersecurity features from the alert and alert metadata and values of asset-based cybersecurity features from retrieved asset metadata. The alert priority scoring system may extract values directly from retrieved data or metadata (e.g., extracting a CVSS score) or extract a value by summarizing retrieved data.

At block 605, the alert priority scoring system generates a first feature vector with the extracted values of the cybersecurity features and submits the first feature vector to the trained organization agnostic classifier of the alert priority scoring ensemble. Generating the first feature vector can include pre-processing of the extracted values. A dashed line represents operational flow from block 605 to block 611.

At block 607, the alert priority scoring system extracts values of preference features from the asset metadata. In other words, the alert priority scoring system reads the values of the variables in the asset metadata that correspond to the preference feature set.

At block 609, the alert priority scoring system generates a second feature vector with the extracted preference feature values. The alert priority scoring system then submits the second feature vector to the organization specific alert classifier. A dashed line represents operational flow from block 609 to block 611.

At block 611, the alert priority scoring system scores the detected alert based on an aggregate of classifications from the classifiers. As previously mentioned, the ensemble can apply weights to each of the classifications and aggregate (e.g., sum) the weighted classifications to generate the score. In addition, the alert priority scoring system can leverage a feature importance tool to provide context for the scoring. The alert priority scoring system associates the score and score context, if generated, with the alert. For instance, the alert priority scoring system decorates the alert with this information.

### Variations

The example descriptions label feature vectors based on alert resolution. Alert resolution can be explicitly indicated with a status of open or resolved and implementations can label a feature vector as important or not important based on multiple factors. For instance, labelling may rely on status and one or more of number of days before the alert was resolved, alert severity, and a resolution descriptor. In addition, this information may be used to filter out alerts from the training data. As an example, an alert that is resolved because the corresponding asset was deleted can introduce noise into training and thus be filtered from the training data. As another example, alerts that have been opened for less than a threshold amount of time may yet be resolved and considered important if resolved before reaching the threshold. Furthermore, alerts for assets that no longer exist or are not alive may be disregarded for various reasons, such as stale or incomplete metadata.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 607 and 609 can be performed prior to or in parallel/concurrently with respect to blocks 603, 605. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

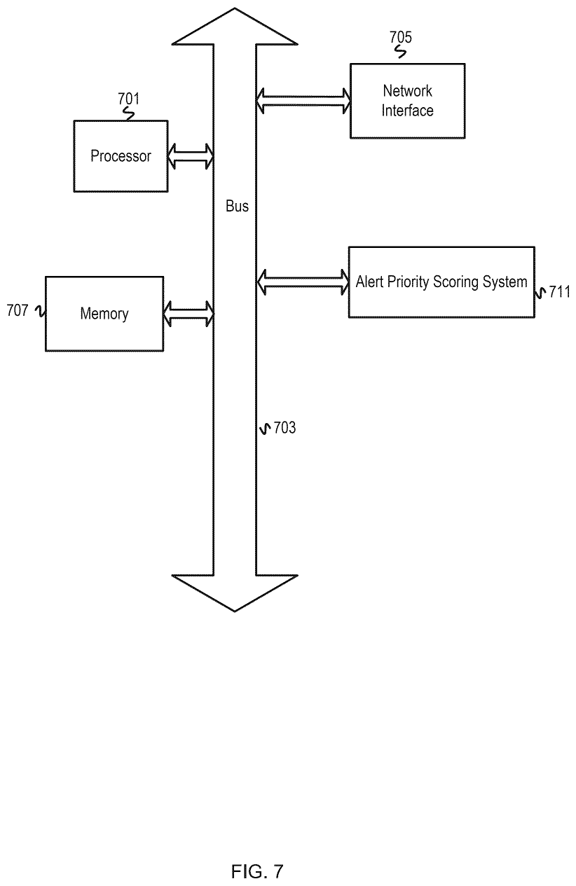

FIG. 7 depicts an example computer system with an alert priority scoring system. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes an alert priority scoring system 711. The alert priority scoring system 711 includes a pre-processing pipeline and an ensemble of classifiers. The pre-processing pipeline retrieves alert data, alert metadata, and metadata of a corresponding asset when an alert is detected. The data and metadata are retrieved according to two feature sets: a first feature set of cybersecurity features and a second feature set of preference features. The cybersecurity features include asset-based features and alert-based features. The preference features are asset-based features that describe assets given “preference” by an organization in terms of alert resolution. The classifiers of the ensemble include a first classifier trained on cross-organization data corresponding to the cybersecurity features and a second classifier trained on the preference features. The alert priority scoring system 711 generates two different feature vectors corresponding to the different feature sets and feeds/inputs each into respective one of the classifiers. The alert priority scoring system 711 scores the detected alert based on an aggregation of classifications output from the classifiers. The alert priority scoring system 711 can also explain the scoring by performing feature importance analysis on the classifications based on the respective feature sets and providing the result of the analysis with the score. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
scoring a cybersecurity alert of an organization, wherein scoring the cybersecurity alert comprises,
extracting first feature values for a first feature set from the cybersecurity alert and from metadata about a cloud-based asset corresponding to the cybersecurity alert, wherein the first feature set comprises cybersecurity features of the cybersecurity alert and cybersecurity features of the cloud-based asset;
extracting second feature values for a second feature set from data specific to a first organization corresponding to the cloud-based asset;
running a first classifier on the first feature values and a second classifier on the second feature values, wherein the first classifier has been trained to classify an alert as critical or not critical based on first training data of the first feature set for resolved cybersecurity alerts across a plurality of organizations and the second classifier has been trained to classify an alert as critical or not critical based on the second feature set in second training data that indicate how the first organization resolved past alerts;
aggregating classifications generated by the first and second classifiers to generate a score; and
associating the score with the cybersecurity alert.

2. The method of claim 1, wherein associating the score with the cybersecurity alert comprises at least one of tagging the cybersecurity alert with the score, generating a notification that indicates the cybersecurity alert and the score, and communicating the cybersecurity alert and the score to a cloud security posture management (CSPM) process.

3. The method of claim 1 further comprising determining whether the score satisfies a threshold for treating the cybersecurity alert as a critical alert and indicating the cybersecurity alert as critical based on determining that the score satisfies the threshold.

4. The method of claim 1, wherein the first and second classifiers are supervised machine learning classifiers.

5. The method of claim 1, wherein aggregating the classifications comprises weighting the classification from the first classifier and weighting the classification from the second classifier and calculating an average of the weighted classifications.

6. The method of claim 1, wherein the cybersecurity features of the cybersecurity alert comprise multiple of severity of a policy corresponding to the cybersecurity alert, category of the policy, duration of the cybersecurity alert, risk complexity corresponding to the cybersecurity alert, exploitability risk corresponding to the cybersecurity alert, collateral damage risk corresponding to the cybersecurity alert, common vulnerability scoring system (CVSS) score indicated in the cybersecurity alert, exploit prediction scoring system (EPSS) score indicated in the cybersecurity alert, technical impact of vulnerability corresponding to the cybersecurity alert, exploitability in the wild of the vulnerability corresponding to the cybersecurity alert, and whether the vulnerability corresponding to the cybersecurity alert can be automated.

7. The method of claim 1, wherein the cybersecurity features of the cloud-based asset comprise multiple of statistics about vulnerabilities corresponding to the cloud-based asset, statistics about cybersecurity issues observed for at least one of the cloud-based asset and the class of the cloud-based asset, statistics about cybersecurity findings of the cloud-based asset in one or more time ranges, qualitative information about cybersecurity findings of the cloud-based asset, attack surface attributes of the cloud-based asset, whether the cloud-based asset hosts sensitive data, privilege of the cloud-based asset, environment of the cloud-based asset, and cybersecurity control on the cloud-based asset.

8. The method of claim 1, wherein the second feature set comprises multiple of name of the cloud-based asset, one or more tags of the cloud-based asset, an account identifier corresponding to the cloud-based asset, type and/or subtype of a policy attached to the cloud-based asset, cloud type, type of the cloud-based asset, geographic region, and whether the policy attached to the cloud-based asset is custom.

9. A non-transitory, machine-readable medium having program code stored thereon, the program code comprising instructions to:
extract first feature values for a first feature set from a cybersecurity alert and from metadata about a cloud-based asset corresponding to the cybersecurity alert, wherein the first feature set comprises cybersecurity features of the cybersecurity alert and cybersecurity features of the cloud-based asset;
extract second feature values for a second feature set from data specific to a first organization corresponding to the cloud-based asset;
invoke a first classifier on the first feature values and a second classifier on the second feature values, wherein the first classifier has been trained to classify an alert as critical or not critical based on first training data of the first feature set for resolved cybersecurity alerts across a plurality of organizations and the second classifier has been trained to classify an alert as critical or not critical based on the second feature set in second training data that indicate how the first organization resolved past alerts;
aggregate classifications generated by the first and second classifiers to generate a score; and
associate the score with the cybersecurity alert.

10. The non-transitory, machine-readable medium of claim 9, wherein the instructions to associate the score with the cybersecurity alert comprise instructions to, at least one of, tag the cybersecurity alert with the score, generate a notification that indicates the cybersecurity alert and the score, and communicate the cybersecurity alert and the score to a cloud security posture management (CSPM) process.

11. The non-transitory, machine-readable medium of claim 9, wherein the program code further comprises instructions to determine whether the score satisfies a threshold for indicating the cybersecurity alert as a critical alert and to indicate the cybersecurity alert as critical based on determining that the score satisfies the threshold.

12. The non-transitory, machine-readable medium of claim 9, wherein the first and second classifiers are supervised machine learning classifiers.

13. The non-transitory, machine-readable medium of claim 9, wherein the instructions to aggregate the classifications comprise instructions to weight the classification from the first classifier and weight the classification from the second classifier and to calculate an average of the weighted classifications.

14. The non-transitory, machine-readable medium of claim 9, wherein the cybersecurity features of the cybersecurity alert comprise multiple of severity of a policy corresponding to the cybersecurity alert, category of the policy, duration of the cybersecurity alert, risk complexity corresponding to the cybersecurity alert, exploitability risk corresponding to the cybersecurity alert, collateral damage risk corresponding to the cybersecurity alert, common vulnerability scoring system (CVSS) score indicated in the cybersecurity alert, exploit prediction scoring system (EPSS) score indicated in the cybersecurity alert, technical impact of vulnerability corresponding to the cybersecurity alert, exploitability in the wild of the vulnerability corresponding to the cybersecurity alert, and whether the vulnerability corresponding to the cybersecurity alert can be automated.

15. The non-transitory, machine-readable medium of claim 9, wherein the cybersecurity features of the cloud-based asset comprise multiple of statistics about vulnerabilities corresponding to the cloud-based asset, statistics about cybersecurity issues observed for at least one of the cloud-based asset and the class of the cloud-based asset, statistics about cybersecurity findings of the cloud-based asset in one or more time ranges, qualitative information about cybersecurity findings of the cloud-based asset, attack surface attributes of the cloud-based asset, whether the cloud-based asset hosts sensitive data, privilege of the cloud-based asset, environment of the cloud-based asset, and cybersecurity control on the cloud-based asset.

16. The non-transitory, machine-readable medium of claim 9, wherein the second feature set comprises multiple of name of the cloud-based asset, one or more tags of the cloud-based asset, an account identifier corresponding to the cloud-based asset, type and/or subtype of a policy attached to the cloud-based asset, cloud type, type of the cloud-based asset, geographic region, and whether the policy attached to the cloud-based asset is custom.

17. An apparatus comprising:
a processor; and
a machine-readable medium having stored thereon instructions executable by the processor to cause the apparatus to,
extract first feature values for a first feature set from a cybersecurity alert and from metadata about a cloud-based asset corresponding to the cybersecurity alert, wherein the first feature set comprises cybersecurity features of the cybersecurity alert and cybersecurity features of the cloud-based asset;
extract second feature values for a second feature set from data specific to a first organization corresponding to the cloud-based asset;
invoke a first classifier on the first feature values and a second classifier on the second feature values, wherein the first classifier has been trained to classify an alert as critical or not critical based on first training data of the first feature set for resolved cybersecurity alerts across a plurality of organizations and the second classifier has been trained to classify an alert as critical or not critical based on the second feature set in second training data that indicate how the first organization resolved past alerts;
aggregate classifications generated by the first and second classifiers to generate a score; and
associate the score with the cybersecurity alert.

18. The apparatus of claim 17, wherein the instructions to associate the score with the cybersecurity alert comprise the instructions being executable by the processor to cause the apparatus to, at least one of, tag the cybersecurity alert with the score, generate a notification that indicates the cybersecurity alert and the score, and communicate the cybersecurity alert and the score to a cloud security posture management (CSPM) process.

19. The apparatus of claim 17, wherein the machine-readable medium further has stored thereon instructions executable by the processor to cause the apparatus to determine whether the score satisfies a threshold for indicating the cybersecurity alert as a critical alert and to indicate the cybersecurity alert as critical based on determining that the score satisfies the threshold.

20. The apparatus of claim 17, wherein the instructions to aggregate the classifications comprise the instructions being executable by the processor to cause the apparatus to weight the classification from the first classifier and weight the classification from the second classifier and to calculate an average of the weighted classifications.
